(19) United States
(12) Patent Application Publication
(10) Pub. No.: US 2026/0367610 A1
(43) Pub. Date: Nov. 19, 2026

(54) COMPUTER-IMPLEMENTED METHOD FOR OPERATING A PROCESSING LINE, AND PROCESSING LINE

(71) Applicants: AVENTUS GMBH & CO. KG, Warendorf (DE); HAVER & BOECKER OHG, Oelde (DE)

(72) Inventors: Thomas KRAUSE, Detmold (DE); Rüdiger GROSSE-HEITMEYER, Westerkappeln (DE); Peer KETTERLE, Hamm (DE); Daniel NARBERHAUS, Tecklenburg (DE)

(21) Appl. No.: 19/480,189

(22) PCT Filed: Apr. 26, 2024
(86) PCT No.: PCT/EP2024/061558

§ 371 Date: Oct. 30, 2025

(30) Foreign Application Priority Data
May 3, 2023 (DE) 10 2023 111 452.2

(51) Int. Cl. G05B 19/418

(52) U.S. Cl. CPC G05B 19/4184

(57) ABSTRACT

A computer-implemented method for operating a processing line, the processing line includes a first plant module with a first control device and a second plant module with a second control device. An evaluation device with a computing device is operatively connected to the first control device of the first plant module and to the second control device of the second plant module. The evaluation device receives a data set from the first control device and a data set from the second control device, wherein the computing device is formed for checking a functionality using an evaluation based on the joint consideration of the data sets using an automated application. The present processing line has a first plant module with a first control device and a second plant module with a second control device and an evaluation device, which is formed for carrying out such a computer-implemented method.

The present invention relates to a computer-implemented method for operating at least one processing line, wherein the processing line comprises at least one first plant module with at least one first control device and at least one second plant module with at least one second control device. The present invention furthermore relates to at least one processing line comprising at least one first plant module with at least one first control device and at least one second plant module with at least one second control device.

Machines or assembly groups, respectively, of plants in a large variety of technical fields often have at least one control device, which controls the respective machine or assembly group, respectively.

At least one sensor or the like is generally installed or provided, respectively, via which the corresponding operating steps of the machine are monitored and/or controlled. This data can then also be used, for example, to control and/or regulate the machine or assembly group, respectively.

This data is expediently also secured and/or stored in the control device, in order to be able to read out information relating to the mode of operation of the machine, e.g., in the case of defects and/or during the maintenance.

If a machine or the control device, respectively, determines a malfunction during operation or if a predetermined result is not achieved, respectively, an error message is often output or a so-called log file is generated or stored, respectively.

In the case of a plant with several machines or assembly groups, it may happen that a certain machine determines an error, which is then also stored, e.g., in the control device. A corresponding error message can furthermore often also be output. Depending on the type of error, however, the latter may have possibly already been created in a different (upstream) assembly group, but shows an effect only in the current assembly group (which detects/outputs the error). An operator can generally not detect this from the error message in the current assembly group, so that he/she can mistakenly be tricked into making settings at the machine or assembly group, respectively, which has output the error message.

Even though this can possibly restore the desired end result because the error is compensated by a changed workflow in the current machine. However, such an approach does not fix the cause of the error and is thus not advantageous.

In particular in the case of more complex plants with several assembly groups, it can thus often be very difficult and time-consuming to correctly localize a malfunction and to thus eliminate the actual cause of an error.

It is thus the object of the present invention to improve a cooperation of several machines or plants, respectively, to the effect that the origin of an error or of a malfunction, respectively, or of an unwanted property, respectively, can be localized better and can preferably be stopped.

This object is solved by means of a computer-implemented method with the features of claim 1 and by means of a processing line with the features of claim 16. Preferred further developments of the invention are subject matter of the subclaims. Further advantages and features of the present inventions follow from the general description and the description of the exemplary embodiment.

The computer-implemented method according to the invention is provided for operating a processing line, wherein the processing line comprises at least one first plant module with at least one first control device and at least one second plant module with at least one second control device. At least one evaluation device with at least one computing device is furthermore provided, wherein the evaluation device is operatively connected at least to the first control device of the first plant module and to the second control device of the second plant module. The evaluation device thereby receives at least one data set from the first control device and at least one data set from the second control device, wherein the computing device is suitable and formed for checking at least one functionality using an evaluation based on the joint consideration of the data sets of the first and of the second control device by means of at least one automated application. At least one predetermined action is then taken.

The evaluation device preferably comprises a storage device, in which the data sets generated by the control devices are stored and processed continuously in different storage locations, depending on the design also according to data set type.

According to the application, in particular the cooperation of at least two plants or plant parts, respectively, or machines, respectively, or assembly groups, respectively, which cooperate at least partly or at least temporarily, respectively, at least indirectly, is understood to be a processing line. The two plant modules can thus in particular perform directly successive processing steps and/or actions. However, other processing steps or actions, respectively, can preferably also be provided between the two plant modules. It is thus in particular also possible that the plant modules are provided spatially separated from one another and that at least one transport step is provided in order to, for example, first process a product by means of the first plant module and by means of the second plant module after the transport.

In particular, a processing line can, for example, be a processing center, wherein the two plant modules of such a processing center can be, for example, a handling device and a conveying device. In preferred designs, a processing line can, for example, also be a classic packing line or a packing department, respectively. The processing line can thus preferably be a packing plant for filling bulk material, liquids and/or the like, wherein such a packing plant comprises, for example, a rotating packing machine and a bag placer assigned to the packing machine. However, the packing plant can alternatively also be provided for filling other packages, in particular when, e.g., liquids are filled. The packages to be filled can then be, for example, barrels, containers, bottles, bulk bags, octabins, pouches and/or the like.

According to the invention, the fact that the computing device is suitable and formed for checking at least one functionality using an evaluation, means in particular that when, for example, at least one certain property, at least one malfunction or at least one error, respectively, is detected, the automated application analyzes the functionality or the malfunction, respectively, or the error, respectively, or the property, respectively, in order to find the cause of the certain property or of the error, respectively, or of the malfunction, respectively.

According to the application, a computing device preferably comprises at least one computer and/or the like and/or is provided by at least one computer and/or the like. A computer can thus also provide the evaluation device, which includes the computing device.

An automated application is in particular at least one processor-based application or a computer-based application, which processes or further processes, respectively, or analyzes, respectively, the data acquired by the control devices, respectively.

The computer-implemented method according to the invention offers many advantages. It is a significant advantage that in the case of malfunctions or errors, respectively, or unwanted results and/or properties, respectively, it is not only detected that something does not run according to specification but that an automated analysis or troubleshooting, respectively, or malfunction determination, respectively, can be carried out by means of the automated application. According to the invention, not only the data from a plant module is considered thereby but the data sets from different control devices are brought together and are analyzed in a joint consideration in order to obtain a detailed image of the processes on the processing line or the individual plant modules, respectively, in order to be able to thus better classify the functionality or a malfunction, respectively, or an error, respectively. Depending on the design, the individual data sets can initially be analyzed in parallel or subsequently also individually.

The cause of the detected functionality (error, property, etc.) can thus preferably be detected and can be stopped accordingly.

For example, properties of a plant module can thus preferably be adapted automatically and/or suitable operating instructions can be given to a user.

Due to the fact that the data from several control devices is considered jointly, it is not only possible to detect a certain functionality or an error, respectively, but connections, which are not trivial or which are complex, respectively, or which are not immediately apparent, respectively, between operating steps and a certain functionality can be detected.

The automated application can thereby in particular consider saved functionalities or examples, respectively, for malfunctions and/or errors. In particular, normal parameters for certain processes can, for example, be saved in a database, wherein the automated application then compares, for example, target and actual values of certain processing steps and relates them to the entire processing process. Depending on the design, different threshold values, e.g., can also be considered here and/or values that drift or tend to change (trends), respectively, can be detected or considered, respectively. For example, an automated application can thus detect that in the case of a second plant module a certain error always occurs when a certain parameter for a specific processing step is present in the case of the first plant module. Depending on the design, for example the wear of certain component parts at a first plant module can thus be detected even if a specific functionality is detected hereby or an error occurs, respectively, only in the case of the second or a next plant module, respectively.

Errors can thus preferably be detected better and more quickly by means of a time-synchronous detection of events of different plant parts and the joint consideration of these events in a uniform system for the cause analysis. Corresponding actions and/or settings can then subsequently be performed in an automated or directed manner in order to stop the error functions. It is furthermore possible to perform a process optimization by means of the joint consideration.

An error pattern is preferably detected based on error rates in the overall context.

A predetermined action, which is taken based on a checked functionality, preferably comprises instructions, a note and/or a report or the output, respectively, of instructions or of a note, respectively, or of a report, respectively. However, an action to be taken can also comprise, for example, at least one change and/or adaptation of at least one setting.

Reports can thereby preferably be sent in an automated manner and can in particular also be divided between plants. The distribution loop can preferably be adapted depending on the checked functionality and/or result of the checking and/or in the case of certain threshold values, wherein in particular an internal and an external distribution and different persons and/or groups of persons are possible.

KPIs (key performance indicator) are preferably determined/created across all machines and are output as report or are displayed in at least one dashboard of the plant, respectively.

The “chat” between machines (from dashboard to dashboard) , between hotline and machine, between machine and production management and/or the like and the use of ready-made reports is also preferred for the quick communication, in particular AI supported for quick responses.

“Outliers” are preferably eliminated from the calculation or are detected, respectively, during the checking. “Outliers” thereby preferably stand out (significantly) from the averaged plurality of values or events, respectively, so that they can be disregarded statically.

The change and/or adaptation of at least one setting or the setting of certain parameters, respectively, can in particular also be used for the process optimization. For example, wait times can thus be stopped, when a process at a following plant has wait times, even though the plant can still increase the performance beforehand. Vice versa, the performance can also be reduced, e.g., in the case of weight fluctuations during a filling process, in order to achieve a better filling accuracy.

The automated application preferably comprises at least one AI application and/or at least one machine-learning application. With the use of artificial intelligence or of machine learning, respectively, a conclusion can particularly advantageously be drawn to specific data with regard to a specific functionality or an error, respectively, or an error property, respectively, and corresponding actions can be taken or operating instructions can be given during the evaluation of the data sets.

The automated application is thereby at least one AI application and/or a machine learning application and/or comprises at least one of these applications. At least one computer vision application can also be provided thereby.

Computer vision thereby in particular refers to the analysis of images and videos with the help of computer programs. In particular the extraction of information contained in the image is the goal of these analyses. Depending on the design, probabilistic methods, image processing methods, projective geometry methods, deep learning methods and computer graphic methods are preferably used thereby.

In the field of the AI application, each application in the field of artificial intelligence can be used, which can advantageously be used with regard to the respective provided evaluation of data sets.

In particular the use of machine learning (ML) is advantageous here, wherein such a machine learning is a sub-field of artificial intelligence (AI). In particular algorithms and methods, which enable programs to learn from data without being programmed explicitly, are a central part of machine learning. These programs can thus preferably make decisions independently.

A differentiation is in particular made between non-monitored and semi-monitored learning. For example, convolutional neural networks (also referred to as space invariant artificial neural networks) and further developments of the convolutional neural networks, such as region based convolutional neural networks, are among the monitored learning methods. However, these modifications of conventional neural networks are in particular not suitable exclusively for image-processing applications because, depending on the design, one or several pre-processing steps are performed upstream of the neural network, including, e.g., convolution operations, depending on the application.

Data of certain states is in particular acquired by means of sensors (e.g., optical sensors, such as, e.g., by means of a camera in color or black/white, thermal image, temperature sensors, vibration sensors, noise sensors, etc., . . . ) and is stored in the respective control device.

The obtained, processed and declared information is then preferably transferred/taught by machine learning or AI methods, respectively, or AI applications, respectively, to a CNN (convolutional neural network).

Data sets from similar processing lines are particularly preferably considered by the automated application. It is thus possible that the automated application does not only learn from the respective processing line but also benefits from the “experience” of other similar processing lines.

In order to teach standard values to the AI application or machine learning application, respectively, it is preferred to already pre-teach standard values of a plant of this type, which has already been constructed repeatedly, to said application or to have a trained operator include the plant values or data sets, respectively, in an interference-free normal operation on side during the start-up and to declare them to be correct or, in the event that deviations occur, to teach them to the AI application as being faulty, respectively.

A guided or directed troubleshooting, respectively, with feedback loop for training the AI or the automated application, respectively, can generally preferably also be provided. The AI can thus be re-trained in a plant-specific and controlled manner.

In expedient designs, at least one data set comprises at least one value. A data set can thereby in particular comprise at least one and preferably a plurality of values, which can comprise, for example, the temperature, the speed, the conveying speed, the weight and/or the like. In the simplest case, a data set can also comprise an individual value, which specifies, for example, a snapshot of a certain parameter.

At least one data set preferably comprises at least one pattern of at least one value. The development of at least one value, for example of the temperature, over time can in particular be included in a data set. Conclusions about certain events can thus be drawn via the pattern of this value and/or of a plurality or variety, respectively, of values or value patterns, respectively.

The data or the development of the data, respectively, on different days and/or of different layers can in particular also be considered.

At least one data set particularly preferably comprises at least one wear indicator (derived from, e.g., longer cylinder running times, increased motor power consumption, longer braking curves, etc.), at least one event log or an even, respectively and/or at least one change of a setting and/or depicts properties of this type.

In expedient further developments, at least one event log is thereby at least one alarm event log. For example, an alarm event log can thus be an error message, which describes, for example, an incorrect property and/or an unwanted result. For example in the field of packing plants, an alarm event log can be the incorrect weight of a filled bag or an excessive weight deviation, respectively, and/or a crooked layer pattern or a pallet that has been packed in a crooked manner, respectively, during the subsequent palletization of filled bags. Depending on the plant, an alarm event log can preferably also be created and/or triggered when reaching predetermined threshold values and/or when detecting values that drift or tend to change, respectively.

In expedient designs, the data from more than one control device for each plant module is considered. It is thus possible in particular that a plant module has several control devices, which can acquire or output, respectively, different data sets. A particularly accurate targeted analysis of functionalities can also be made hereby with the automated application.

The data is preferably considered by the control devices of more than two plant modules. In particular in the case of more complex processing lines, for example in the case of packing plants, which can comprise, for example, a bag production, a bag placer, a packing machine and a following loading device, the joint consideration of the data sets from more than two plant modules can be used in a particularly effective manner in order to analyze functionalities or malfunctions, respectively.

In the case of an alarm event log of a plant module, the evaluation device or the computing device, respectively, or the automated application, respectively, particularly preferably examines this data set with the data sets from different further plant modules. In particular in the case of an alarm event log in the case of a control device, a comparison with the data or event logs, respectively, or alarm event log, respectively, of other plant modules can be made thereby. The analysis can thereby take place, e.g., one after the other, simultaneously and/or also sequentially. It is thus possible in particular that the automated application in the case of a detected error in a plant module or in the case of an alarm event log, respectively, goes looking for the trigger of this error. It can in particular be analyzed up to which processing step or in the case of which plant module, respectively, all operating steps or operating results, respectively, still complied with the standard or were normal, respectively. In the event that an error occurs, a note can also be issued to a user that an action that seems obvious at first glance, for example a change or adaptation, respectively, of a parameter, is to be refrained from because the existing error can in fact not be found at the obvious level but can be found at a completely different location by means of the evaluation of the data sets from the different control devices. The alarm event logs from different days and/or different layers can in particular also be considered or compared, respectively.

At least one plant module from at least one technical field is preferably provided, which is selected from a group of technical fields comprising filling technology, packing plants, conveying technology, processing technology, storage technology and/or logistics.

The processing line in particular comprises at least one packing plant and/or is formed as such. A packing plant can in particular be formed as a packing plant for filling bulk material or free-flowing and/or pourable solids, and/or a filling plant for filling liquid and/or paste-like products. The packages to be packed or filled, respectively, can then be, for example, bags, barrels, pouches, bottles, containers, canisters, bulk bags, octabins and/or the like.

At least one plant module of the packing plant is then preferably selected from a list, which comprises: feed hopper, bucket conveyor, intermedia silo, filter plant (with fan), screening plant, distribution channel, hopper battery, silo withdrawal technology (e.g., screw conveyor), mixing and/or batch silos, mixers, metering device, distribution chute, conveyor belt, product silos, silo withdrawal technology, bulk loading head, vehicle logistics, feed bin, withdrawal slide, (rotating) packing machine, empty bag storage, bag production, collector and transport for leaking product, bag placer, discharge line (e.g., comprising: discharge belt, bag cleaning), side channel blower, belt check weigher, bag rejection, conveyor line, metal detector, front cord, bag distribution, palletizer (e.g., comprising storage table, lifting table, etc.), empty pallet feed, full pallet transport (e.g., as roller conveyor, chain conveyor, etc.), corner transfer conveyor, pressing and/or turnover device, hooder and/or stretch hooder, pallet acceptance, mobile conveying technology (e.g. stacker) and storage logistics. All plant modules of the packing plant are thereby in particular taken from the list or the technical field, respectively, of packing plants. If a filling plant is comprised, known plant modules can accordingly be comprised for a plant of this type.

At least one universal diagnostic interface is preferably provided for a service technician.

In expedient further developments, maintenance and repair protocols are stored and are considered during the evaluation.

Preferably, at least one sensor is provided, which detects cross-plant peculiarities, such as, e.g., an extraordinary noise development, a temperature (change), a dust development and/or the like. Suitable thermal, acoustic, optical, vibration-sensitive sensors and/or the like can be used at a suitable location for this purpose.

Based on the evaluation, notes, instructions and/or videos are preferably selected from a library and are offered to a user. For example, a display can thereby be provided on a monitor, VR glasses and/or the like. These notes, instructions and/or videos can be created based on earlier evaluations of the same plants and/or plant types. The notes, instructions and/or videos are preferably kept in a database in the local network or in a cloud application or so as to be accessible from anywhere, respectively (Internet).

The processing line according to the invention comprises at least one first plant module with at least one first control device and at least one second plant module with at least one second control device. At least one evaluation device with at least one computing device is furthermore comprised, which is suitable and formed for carrying out at least one computer-implemented method, as it has been described above.

The processing line according to the invention also offers the advantages, as they have already been described above with regard to the computer-implemented method according to the invention.

Further advantages and features of the present invention follow from the exemplary embodiment, which will be explained below with reference to the enclosed figures.

In den Figures:

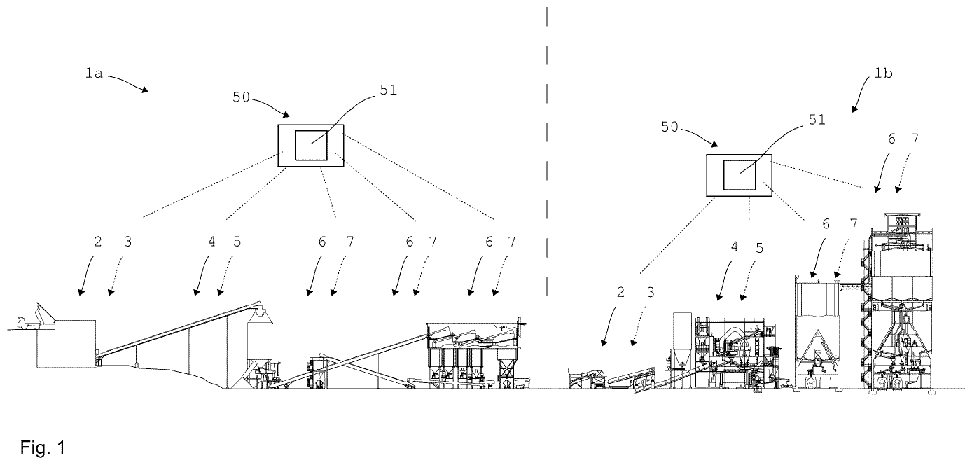

FIG. 1 shows a purely schematic illustration of two exemplary embodiments of processing lines according to the invention, which are arranged next to one another, in a lateral sectional view;

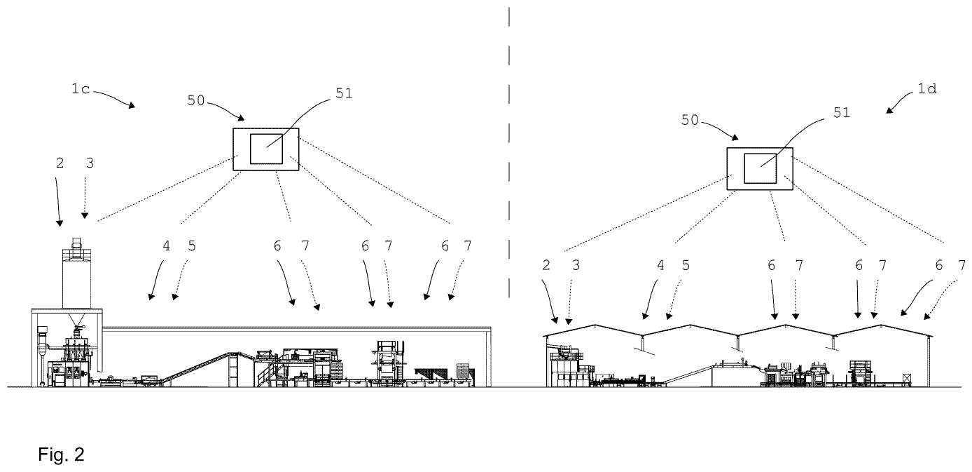

FIG. 2 shows a purely schematic illustration of two further exemplary embodiments of processing lines according to the invention, which are arranged next to one another, in a lateral sectional view;

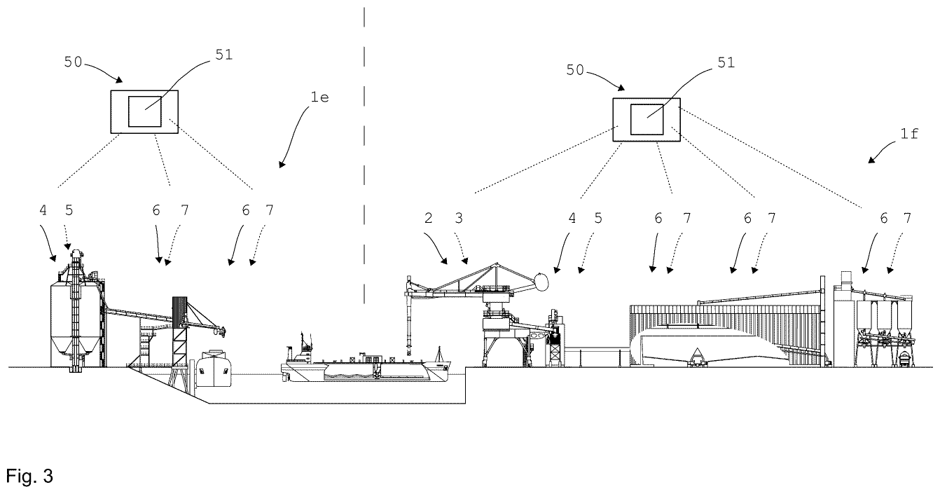

FIG. 3 shows a purely schematic illustration of two next exemplary embodiments of processing lines according to the invention, which are arranged next to one another, in a lateral sectional view; and

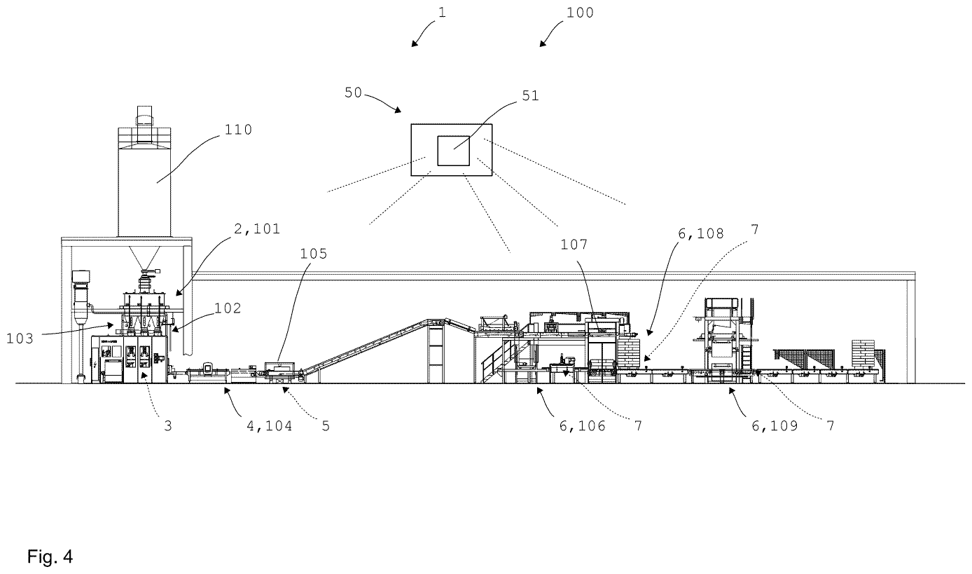

FIG. 4 shows the left processing line from FIG. 2 in an enlarged illustration.

A total of six exemplary embodiments of processing lines 1 according to the invention (1a to 1f) are illustrated in FIGS. 1 to 3, which are to be assigned here in an exemplary manner to the field of processing or packaging, respectively, of bulk materials, such as, e.g., cement.

The processing line la is, for example, an open pit mine line for rock with primary crushing, crushing and sorting plant as well as storage silos.

The processing line 1b is a mixing and storage plant for, e.g., mineral building materials and a loading terminal.

The processing line 1c is a packing plant, which comprises here, for instance, a bulk material bagging, a palletization as well as a cargo/weather protection hooder.

The processing line 1d is another exemplary configuration of a packing plant.

The processing line le is a ship loading plant (in particular for bulk materials) and the processing line 1f is a ship unloading terminal with further processing plant.

Each of these processing lines la to 1f consists of a plurality of plant modules 2, 4, 6, wherein a processing line 1 according to the invention generally comprises at least one first plant module 2 and a second plant module 3.

The exemplary embodiments of processing lines 1 (1a-1f) according to the invention, which are shown here, in each case comprise a first plant module 2, a second plant module 3 and several further plant modules 6, which are only suggested schematically in the figures. These plant modules 2, 4, 6 each have a control device 3, 5, 7, which are not illustrated in detail in FIGS. 1 to 3.

Each plant module 2, 4, 6 can be, e.g., an independent machine, a plant and/or an assembly group. Each plant module thereby comprises a control device 3, 5, 7, which receives or acquires, respectively, or stores, respectively, data or values, respectively, relating to the state and/or the mode of operation of the plant modules 2, 4, 6 and/or the like via sensors or another suitable monitoring. Such data is then saved or stored, respectively, in the storage device. Different storage locations can thereby be provided for different data sets.

Values and/or value patterns, which are characteristic for the operation of the corresponding module, can in particular be stored. A temperature, a pressure, a speed and/or a weight can be named in an exemplary manner here. However, a data set can, for example, also depict or comprise, respectively, at least one wear indicator, at least one event log (event) and/or at least one change of a setting.

According to the invention, a processing line 1 comprises at least one evaluation device 50 with at least one computing device 51, wherein the evaluation device 50 or the computing device 51, respectively, can receive at least data or data sets, respectively, from the first control device 3 and the second control device 5. In the shown exemplary embodiments in FIGS. 1 to 3, the evaluation device 50 or the computing device 51, respectively, is in operative connection with the control devices 3, 5, 7 of all plant modules 2, 4, 6.

Depending on the exemplary embodiment, the evaluation devices 50 of different processing lines 1 (1a-1f) can also exchange data with one another. The networking of several similar processing lines 1 can also be advantageous.

The evaluation device 50 or the computing device 51, respectively, is suitable and formed for receiving data sets from several (at least two) control devices 3, 5, 7 and for checking at least one functionality using an evaluation based on the joint consideration of the data sets by means of at least one automated application.

The evaluation device 50 or the computing device, respectively, can thereby in particular use an AI application or a machine learning application, respectively, as it is described in an exemplary manner in this application.

With the automated application or the automated analysis, respectively, or joint consideration, respectively, of data sets from different plant modules 2, 4, 6 or the control device 3, 5, 7 thereof, respectively, it becomes possible to also analyze complex connections of changes of parameters, properties or errors, respectively, or malfunctions, respectively. Error sources can thus be localized significantly better and more quickly.

An operator of such a processing line 1 or of a plant module 2, 4, 6, respectively, would generally be overwhelmed with permanently monitoring all data pools of all control devices 3, 5, 7 of all plant modules 2, 4, 6 and even if the data patterns were visualized in diagrams, an operator cannot superimpose said data patterns and detect deviations or complex connections, respectively, in this way.

An exemplary embodiment of a processing line 1, as it is has already been shown in FIG. 2 (processing line 1c), is shown purely schematically in FIG. 4.

This processing line 1 is formed as packing plant 100 here, which comprises a plurality of plant modules 2, 4, 6 with the respective control devices 3, 5, 7. The control devices 3, 5, 7 are not illustrated concretely thereby but are only suggested via the dotted arrows.

The packing plant 100 thereby in particular comprises a packing machine 101 as plant module 2, which is formed as FFS packing machine (form-fill-seal) here.

The packing machine illustrated here comprises a net weight scale 102, to which a metering device 103 is assigned, to which product to be filled is fed from a silo 110.

Further plant modules 4, 6 are, for example, conveyor line 104 with a check weigher 105, a palletizer 106 with a storage table 107, underneath which empty pallets can be arranged. A full pallet transport 108 and a stretch hooder 109 is furthermore provided.

Here, the processing line 1 also comprises at least one evaluation device 50 with at least one computing device 51, wherein the evaluation device 50 or the computing device 51, respectively, can receive data or data sets, respectively, from the control devices 3, 5, 7. The networking or data connection, respectively, between the evaluation device 50 or the computing device 51, respectively, is suggested via the dashed lines.

The evaluation device 50 or the computing device 51, respectively, is suitable and formed for receiving data sets from the control devices 3, 5, 7 and for checking at least one functionality using an evaluation based on the joint consideration of the data sets by means of at least one automated application.

Here, the evaluation device 50 or the computing device, respectively, can draw conclusions to certain functionalities or errors, respectively, by means of an AI application or a machine learning application, respectively.

In the case of a plant, as it is illustrated in an exemplary manner in FIG. 4, it can happen that after a longer plant runtime (e.g. months), the bag weights of the net weight scale 102 of a packing machine 101 tend to be higher at the beginning of a batch during the check weighing on the check weigher 105 than weighed by the net weight scale 102, even though the net weight scale 102 has generally weighed correctly and nothing has actually been changed otherwise.

The weights match again later in the batch. As the cause, the metering device 103 is detected before the net weight scale 102, the sealing effect of which becomes worse due to the onset of wear.

At the beginning of a batch with high silo fill level, the product pressure is higher and leads to a slight trickling even when the metering device 103 is closed, which the net weight scale 102 no longer detects because it already empties into the bag, which is to be filled. If the product pressure falls with the fill level, the seal manages to prevent this trickling again.

Such a connection can be uncovered by means of the method according to the invention or possible error sources can at least be restricted better.

Due to the fact that the evaluation device 50 or the computing device 51, respectively, can monitor or evaluate, respectively, the data sets from all plant modules jointly, individually and/or also sequentially in a joint consideration, error sources can be found or determined better, respectively.

In the above-described example, the automated application, in particular by using at least one AI application or at least one machine learning application, respectively, can draw conclusions to the error or the determined functionality, respectively, namely temporary deviations between the values of the net weight scale 102 and of the check weigher 105, e.g., from the data relating to the fill level of the silo 110, the data from the net weight scale 102 and of the check weigher 105 and, e.g., the maintenance interval of the metering device 103 or generally from the operating time of the plant 100, respectively, or packing machine, respectively.

In abstract terms, the automated application or the AI application, respectively, or the machine learning application, respectively, would perform a, preferably permanent, reconciliation of data and would report peculiarities, e.g., deviations, which result.

For this purpose, data is preferably taught to the automated application or the AI application, respectively, or the machine learning application, respectively, for a certain period of time, for example also with the operation of the plant, while the latter runs correctly. This is preferably accompanied by a trained service technician during the learning phase.

Such a learning phase can be expanded thereby, e.g., when the automated application has detected states, which do not comply with the taught standard.

Depending on the design, it can also be provided that an operator decides whether a detected state is still tolerable, is to thus be considered to be in order in the future, or whether this is a faulty operating state. However, such an approach with options for intervention by an operator can also have negative impacts. On the one hand, the system or the automated application, respectively, can become “smarter” thereby and, to a certain extent, more error-tolerant, while, on the other hand, even typical gradual changes, which, when detected early on, can prevent larger damages, can also be “pushed away” quickly because this is easier for the operator at that moment. The system or the automated application, respectively, would then become worse or “dumber”, respectively.

A further application example in the case of the processing line 1 shown in FIG. 4 lies in the field of palletizing. The so-called layer pattern of a pallet fluctuates strongly. (Almost) perfect layers can occur thereby. However, less optimal layer patterns and even bags sticking out occur again and again. This leads to problems again and again during the packaging of the pallet, e.g., by means of a stretch hooder.

The cause for this, which is determined by the automated application or here the AI application, respectively, or the machine learning application, respectively, is that the bagging machine has to check-weigh a bag after a fixedly specified number of produced bags.

The production speed of the machine is reduced automatically for this purpose. The bags consequently arrive at the palletizer with larger gaps. Due to this delay, it can occur that bag conveyor belts stop briefly. This can have the result that bags slightly lose their shape. This is generally compensated by means of guide and formatting plates in or on the palletizer, respectively.

However, prior to the analysis of the automated application, the operators had suspected that the perceived problem of the bag shape change would need to be adapted or compensated, respectively, again and again by correcting the bag positioning in the palletizer via inputs in the corresponding control. These adaptations by the operator have caused the highly fluctuating layer pattern of the pallet.

The automated application or here the AI application, respectively, or the machine learning application, respectively, was able to find the cause from a combination of the event information of the different control devices 3, 5, 7 of the individual plant modules 2, 4, 6 (alarm event log from the stretch hooder, FFS bag event of the packing machine and parameter change event of the palletizer) and was able to give corresponding instructions to the operators. An operator would not have been able to cut through this complex connection or the cooperation of several plant modules 2, 4, 6, respectively, for the supposed error.

### LIST OF REFERENCE NUMERALS

1 processing line
1a-f processing line
2 first plant module
3 first control device
4 second plant module
5 second control device
6 further plant module
7 further control device
50 evaluation device
51 computing device
100 packing plant
101 packing machine
102 net weight scale
103 metering device
104 conveyor line
105 check weigher
106 palletizer
107 storage table
108 full pallet transport
109 stretch hooder
110 silo

1. A computer-implemented method for operating at least one processing line, wherein the processing line comprises at least one first plant module with at least one first control device and at least one second plant module with at least one second control device;
at least one evaluation device with at least one computing device is provided; wherein the evaluation device is operatively connected at least to the first control device of the first plant module and to the second control device of the second plant module;
the evaluation device receives at least one data set from the first control device and at least one data set from the second control device; and that the computing device is suitable and formed for checking at least one functionality using an evaluation based on the joint consideration of the data sets by means of at least one automated application in order to then perform at least one predetermined action.

2. The computer-implemented method according to claim 1, wherein the action to be taken comprises the output of a note, of instructions and/or of a report and/or the change and/or adaptation of at least one setting.

3. The computer-implemented method according to claim 1, wherein the automated application comprises at least one KI application and/or at least one machine learning application.

4. The computer-implemented method according to claim 1, wherein the automated application considers said at least one data set from similar processing lines.

5. The computer-implemented method according to claim 1, wherein said at least one data set comprises at least one value.

6. The computer-implemented method according to claim 1, wherein said at least one data set comprises at least one pattern of at least one value.

7. The computer-implemented method according to claim 1, wherein the at least one data sets from different days and/or from different layers are considered.

8. The computer-implemented method according to claim 1, wherein said at least one data set depicts/comprises at least one wear indicator, at least one event log (event) and/or at least one change of a setting.

9. The computer-implemented method according to claim 8, wherein said at least one event log is an alarm event log.

10. The computer-implemented method according to claim 1, wherein the data from more than one control device for each plant module is considered.

11. The computer-implemented method according to claim 1, wherein the data from the control devices from more than two plant modules is considered.

12. The computer-implemented method according to claim 1, wherein in the case of an alarm event log of a plant module the evaluation device examines a select one of said at least one data set with the data sets from different further plant modules.

13. The computer-implemented method according to claim 1, wherein at least one plant module from at least one technical field is comprised, which is selected from a group of technical fields comprising filling technology, packing plants, conveying technology, processing technology, storage technology and/or logistics.

14. The computer-implemented method according to claim 1, wherein the processing line comprises at least one packing plant and/or at least one filling plant and/or is formed as such.

15. The computer-implemented method according to claim 14, wherein at least one plant module of the packing plant is selected from a list, which comprises: feed hopper, bucket conveyor, intermedia silo, filter plant, screening plant, distribution channel, hopper battery, silo withdrawal technology, mixing and/or batch silos, mixer, metering device, distribution chute, conveyor belt, product silos, silo withdrawal technology, bulk loading head, vehicle logistics, feed bin, withdrawal slide, (rotating) packing machine, empty bag storage, bag production, collector and transport for leaking product, bag placer, discharge line, side channel blower, belt check weigher, bag rejection, conveyor line, front cord, bag distribution (mostly integrated in the palletizer), palletizer, full pallet transport, corner transfer conveyor, pressing and turnover device, hooder, stretch hooder, pallet acceptance, mobile conveying technology and/or storage logistics.

16. A processing line comprising at least one first control plant module with at least one first control device and at least one second plant module with at least one second control device, including at least one evaluation device with at least one computing device, which is formed for carrying out at least one computer-implemented method according to claim 1.
